(19) United States
(12) Patent Application Publication
(10) Pub. No.: US 2012/0100424 A1
(43) Pub. Date: Apr. 26, 2012

(54) CATHODE ACTIVE MATERIAL, AND CATHODE AND MAGNESIUM BATTERY INCLUDING THE SAME

(75) Inventors: Seok-soo LEE, Yongin-si (KR); Young-gyoon Ryu, Suwon-si (KR); Jung-wook Seo, Hwaseong-si (KR); Young-min Choi, Suwon-si (KR)

(73) Assignees: Samsung Electro-Mechanics Co., Ltd, Suwon-si (KR); Samsung Electronics Co., Ltd., Suwon-si (KR)

(21) Appl. No.: 13/118,903

(22) Filed: May 31, 2011

(30) Foreign Application Priority Data
Oct. 20, 2010 (KR) 10-2010-0102508

(51) Int. Cl. H01M 10/056; H01M 6/14; C01G 23/00; H01M 4/13

(52) U.S. Cl. 429/206; 429/231.5; 429/231.6; 423/561.1; 429/218.1

(57) ABSTRACT

Cathode active materials, and cathodes and magnesium batteries including the cathode active materials. The cathode active materials, and cathodes and magnesium batteries include a metal sulfide-based nanosheet.

### CROSS-REFERENCE TO RELATED APPLICATIONS

This application claims the benefit of Korean Application No. 10-2010-0102508, filed Oct. 20, 2010, in the Korean Intellectual Property Office, the disclosure of which is incorporated herein by reference.

### BACKGROUND OF THE INVENTION

1. Field

The present disclosure relates to cathode active materials, cathodes, and electrochemical devices; e.g., magnesium batteries, and more particularly, to cathode active materials comprising metal sulfide-based nanosheets, cathodes and electrochemical devices such as magnesium batteries which include the cathode active materials.

2. Description of the Related Art

Recently, the demand for materials for power storage batteries has increased.

Magnesium batteries are environmentally friendly, competitive in terms of price, and capable of storing high amounts of energy compared to traditional lithium batteries, lead storage batteries, nickel-cadmium batteries, nickel-hydrogen batteries, and nickel-zinc batteries. Due to these characteristics, research into magnesium batteries is actively being performed.

A conventional magnesium battery includes a cathode typically comprising a metal sulfide-based active material having a bulk form, such as Mo₆S₈, an anode including a magnesium-based active material, such as magnesium or an alloy thereof, and an electrolyte prepared by dissolving a magnesium salt in an organic solvent.

However, a metal sulfide-based active material having a bulk form, for example, having a size on the order of micrometers or greater, does not efficiently intercalate or deintercalate a bivalent magnesium ion (i.e., Mg²⁺). Thus, when the metal sulfide-based active material is used in a cathode of a magnesium battery, it is difficult to realize high capacitance. Accordingly, there is a need for cathode active materials capable of realizing high capacitance by efficiently intercalating or deintercalating magnesium ions when used in a cathode of an electrochemical device such as a magnesium battery.

### SUMMARY OF THE INVENTION

An embodiment of the invention comprises novel cathode active materials; more particularly, metal sulfide-based nanosheets.

The present invention also provides novel cathodes which include the above-described cathode active materials.

The present invention further provides novel electrochemical devices, including magnesium batteries which contain the above-described cathodes.

Additional aspects and embodiments of the invention will be set forth, in part in the description which follows and, in part, will be apparent from the description, or may be learned through practice of the presented embodiments by those skilled in the art..

One embodiment of the present invention relates to a cathode active material comprising a metal sulfide-based nanosheet.

The metal sulfide-based nanosheet may comprise a titanium sulfide.

More particularly, the titanium sulfide-based nanosheet comprises titanium disulfide.

The metal sulfide-based nanosheet may be configured as a multi-layered structure.

The multi-layered metal sulfide-based nanosheet may comprise 2 (two) to 50 (fifty) layers, each having a thickness of about 0.2 to about 0.8 nm, each layer being a crystalline compound having horizontal (W) and vertical (V) lengths of 500 nm or less..

Another embodiment of the present invention concerns a cathode which includes the cathode active material described above.

According to another aspect of the present invention, an electrochemical device is provided, such as, e.g., a magnesium battery which includes the cathode described above; an anode; and an electrolyte disposed to contact the cathode and the anode.

The anode includes an anode active material subject to oxidation to produce magnesium ions.

The anode active material preferably includes at least one material selected from the group consisting of monolithic magnesium and magnesium-containing alloys.

The electrolyte may be a non-aqueous electrolyte containing magnesium ions.

The magnesium battery may be a primary or secondary battery.

Additional aspects and/or advantages of the invention will be set forth in part in the description which follows and, in part, will be obvious from the description, or may be learned through practice of the invention by those skilled in the art.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a multi-layered metal sulfide-based nanosheet according to an embodiment of the present invention;

FIG. 2 is a view for explaining intercalating of magnesium ions to or deintercalating of magnesium ions from the multi-layered metal sulfide-based nanosheet of FIG. 1;

FIG. 3 is a scanning electron microscope (SEM) image of a multi-layered metal sulfide-based nanosheet manufactured according to Example 1;

FIG. 4 is an X-ray diffraction (XRD) spectrum of a multi-layered metal sulfide-based nanosheet manufactured according to Example 1; and

FIG. 5 is a graph of a cyclic life performance of each of batteries including cathode active materials prepared according to Example 1 and Comparative Example 1.

### DETAILED DESCRIPTION

Reference will now be made in detail to the embodiments of the present invention, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, with reference to the attached drawings, cathode active materials according to embodiments of the present invention, and cathodes and magnesium batteries including the cathode active materials will be described in detail.

A cathode active material according to an embodiment of the present invention comprises a metal sulfide-based nanosheet. The term ‘metal sulfide-based nanosheet’ used herein refers to a sheet-shaped and single- or multi-layered crystalline metal sulfide-based compound(s) having a layer-thickness that is on the order of nanometers, and vertical and horizontal lengths that are on the order of nanometers to micrometers, respectively.

The nanosheet may comprise a titanium sulfide.

More particularly, the titanium sulfide-based nanosheet comprises titanium disulfide (TiS₂).

The metal sulfide-based nanosheet may comprise a multi-layered structure.

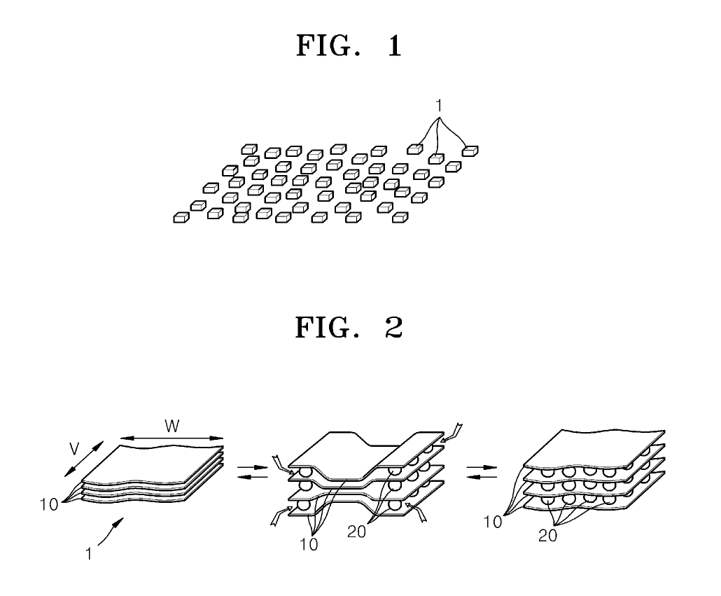

FIG. 1 is a schematic view of a multi-layered metal sulfide-based nanosheet 1 according to an embodiment of the present invention, and FIG. 2 is a view that explains the intercalation of magnesium ions 20 to or the deintercalation of magnesium ions 20 from the multi-layered metal sulfide-based nanosheet 1 of FIG. 1.

The cathode active material may include at least one of the multi-layered metal sulfide-based nanosheets 1. The multi-layered metal sulfide-based nanosheet 1 may include two or more layers 10 stacked upon each other.

For example, the multi-layered metal sulfide-based nanosheet 1 may be a crystalline compound (see FIG. 4) having 2 (two) to 50 (fifty) layers 10, each having a thickness of about 0.2 to about 0.8 nm, and horizontal (W) and vertical (V) lengths of 500 nm or less, for example, 200 nm or less.

Referring to FIG. 2, in the multi-layered metal sulfide-based nanosheet 1, a weak van der Waals force may occur between neighboring layers 10, thereby forming voids therebetween. Through the voids, magnesium ions 20 are easily intercalated to or deintercalated from the multi-layered metal sulfide-based nanosheet 1.

The cathode active material may be used in any electrochemical device, including, for example, primary and secondary magnesium batteries.

A cathode according to an embodiment of the present invention includes the cathode active material. The cathode may further include a binder and/or a conductive agent. The cathode may be prepared by, for example, molding a cathode forming composition including the cathode active material, a binder, and a conductive agent into a given shape, or coating the cathode forming composition on a copper foil or a stainless steel foil.

The binder enables particles of the cathode active material to be attached to each other and also to a current collector. Examples of the binder are polyvinylalcohol, carboxymethylcellulose, hydroxypropylcellulose, diacetylcellulose, polyvinylchloride, carboxylated polyvinylchloride, polyvinylfluoride, ethyleneoxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, and a combination thereof.

The conductive agent is used to provide conductivity to the cathode, and may be any material that does not cause chemical changes and which conducts electrons. Examples of suitable conductive agents are carbonaceous materials such as natural graphite, artificial graphite, carbon black, acetylene black, ketjen black, or carbon fiber; metallic powder or metallic fiber of copper, nickel, aluminum, or silver; conductive materials such as a polyphenylene derivatives; and combinations thereof.

A magnesium battery according to an embodiment of the present invention includes the cathode, an anode, and an electrolyte disposed to contact the cathode and the anode.

The anode may include an anode active material which generates magnesium ions when oxidized.

The anode active material preferably includes at least one material selected from the group consisting of monolithic magnesium and magnesium-containing alloys.

The anode active material and the anode may be, for example, a magnesium foil.

As another example, the anode may additionally include a binder and/or a conductive agent identical or similar to those used in manufacturing the cathode as described above.

The electrolyte for use in the magnesium battery may be a non-aqueous electrolyte including magnesium ions. For example, the electrolyte may be a solution prepared by dissolving a magnesium salt, such as Mg(AlCl₂EtBu)₂, in an organic solvent, such as tetrahydrofuran (THF). In [Mg(AlCl₂EtBu)₂] described above, Et means an ethyl group and Bu means a butyl group.

Another example of the electrolyte is a solid electrolyte.

The magnesium battery may further include a separator for physically and electrically separating the cathode from the anode.

The separator may be any one of those commonly used in conventional magnesium batteries. Examples of suitable separators are glass fiber, polyester, Teflon, polyethylene, polypropylene, polytetrafluoroethylene (PTFE), and a combination thereof. In addition, the separators may have a woven or nonwoven form.

The magnesium battery may be a primary or secondary battery. If the magnesium battery is a secondary battery, during discharging, magnesium ions are intercalated into the metal sulfide-based nanosheets, and during charging, magnesium ions are deintercalated from the metal sulfide-based nanosheets.

A magnesium battery having the structure as described above may be used as a power storage battery, or a power source device for vehicles.

One or more embodiments will now be described in further detail with reference to the following examples. These examples are for illustrative purpose only and are not intended to limit the scope of the one or more embodiments.

### Example 1

### Preparation of TiS₂ Nanosheet as Cathode Active Material

90 μl of TiCl₄ and 3 g of oleylamine were placed in a flask vessel and heated at a temperature of 300° under an argon gas atmosphere. Then, at the temperature of 300° C., 0.12 Ml of carbon disulfide was added to the flask vessel and the temperature was maintained constant for 30 minutes and then decreased to room temperature. Then, 20 mL of acetone was added to the flask vessel; and the nanoparticles formed were precipitated, and collected by centrifuge.

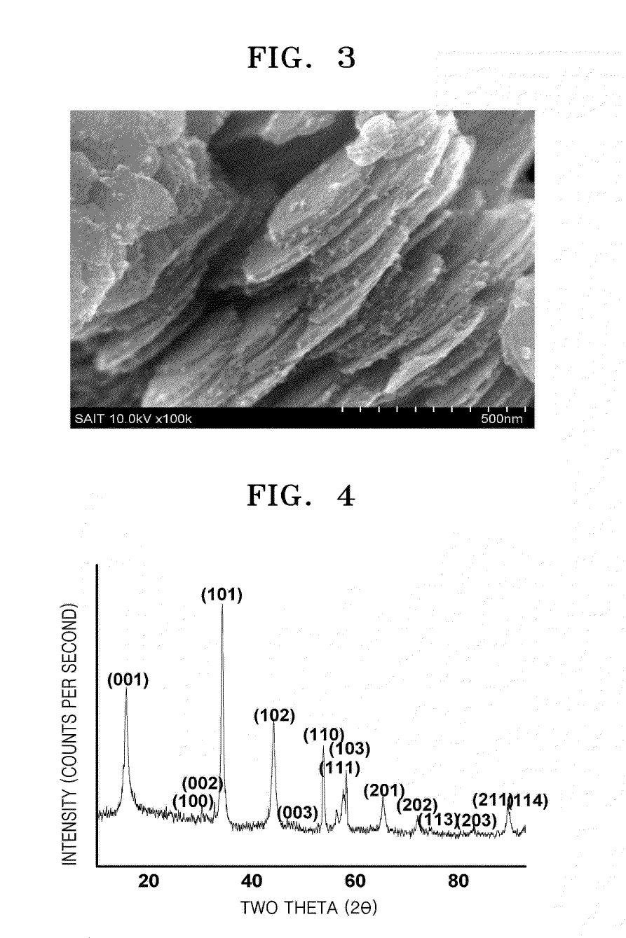

FIG. 3 shows a scanning electron microscope (SEM) image of the prepared TiS₂ nanosheet. The SEM model is JSM-7400F manufactured by JEOL Inc.

### Comparative Example 1

### Bulk-Form TiS₂ as Cathode Active Material

Bulk-form TiS₂ (Sigma-Aldrich, Cat. No.: 333492) was prepared.

### EVALUATION EXAMPLE

### Evaluation Example 1

### XRD Analysis of Cathode Active Material

An X-ray diffraction (XRD) spectrum of the cathode active material prepared according to Example 1 was measured and the results are shown in FIG. 4. The device used for XRD was D/Max-2500VK/PC manufactured by Rikagu Inc.

Referring to FIG. 4, the cathode active material prepared according to Example 1, a TiS₂ nanosheet, has a hexagonal close-packed crystal structure. In FIG. 4, reference numerals (for example, (101)) refer to the crystal surface indices.

### Evaluation Example 2

### Battery Performance Test

Coin-type batteries were manufactured using the cathode active materials prepared according to Example 1 and Comparative Example 1, and the performances thereof were evaluated.

### (Preparation of Cathode)

8 parts by weight of the cathode active material prepared according to Example 1 or Comparative Example 1, 1 part by weight of ketjen black (EC-600JD), and 1 part by weight of polyvinylidene fluoride (PVDF) were mixed and the resulting mixture was dispersed in N-methyl-2-pyrrolidone (NMP), thereby preparing a cathode forming slurry. Then, the slurry was coated on a 10 μm-thick stainless steel foil and dried, followed by compression with a press machine, thereby manufacturing a cathode.

### (Preparation of Magnesium Battery)

A coin-type secondary magnesium battery was manufactured using the cathode prepared as described above, a magnesium foil as an anode, a separator, and an electrolyte. In this experiment, a glass filter (Whatman, GF/F) was used as a separator, and 0.25M Mg(AlCl₂EtBu) dissolved in tetrahydrofuran (THF) was used as an electrolyte. For each case, a plurality of the same coin-type secondary magnesium batteries were manufactured.

### (Battery Performance Test)

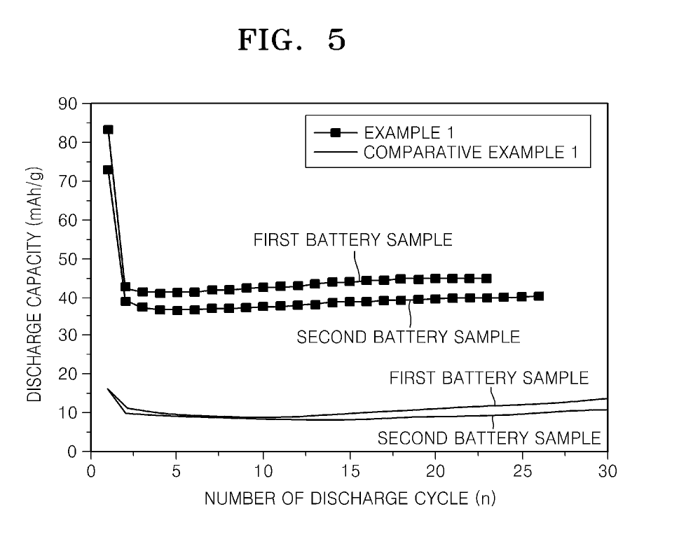

Charge and discharge performances of the manufactured batteries were tested in a constant-current evaluation manner, and the results are shown in FIG. 5. In this regard, the voltage was in a range of about 0.5 to about 1.9 V, and the current density was 10 μA/cm². In FIG. 5, n refers to the number of discharge cycles.

FIG. 5 is a graph of charge capacity with respect to the number of discharge cycles. Also, in FIG. 5, in order to evaluate reproducibility, two batteries manufactured using the cathode active material prepared according to Example 1, that is, the TiS₂ nanosheet, and two batteries manufactured using the cathode active material prepared according to Comparative Example 1, that is, bulk-form TiS₂, were tested and the cycle life performances of the four batteries are shown.

Referring to FIG. 5, the batteries manufactured using the cathode active material prepared according to Example 1, i.e., the TiS₂ nanosheet, show higher discharge capacity than the batteries manufactured using the cathode active material prepared according to Comparative Example 1, i.e., bulk-form TiS₂. In addition, the charge capacity of the batteries manufactured using the cathode active material prepared according to Example 1 is constant with respect to the number of discharge cycles, except for the case of the first discharge cycle (n=1).

Also, referring to FIG. 5, the two batteries manufactured in the same manner according to the Example 1 show very similar cycle life performances, thus confirming that they have good reproducibility.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cathode active material comprising at least one metal sulfide-based nanosheet.

2. The cathode active material of claim 1, wherein the metal sulfide is a titanium sulfide.

3. The cathode active material of claim 2, wherein the titanium sulfide is titanium disulfide.

4. The cathode active material of claim 1 comprising at least two metal sulfide-based nanosheets in a multi-layered structure.

5. The multi-layered cathode active material of claim 4, comprising 2 to 50 layers, each having a thickness of about 0.2 to about 0.8 nm, wherein each metal sulfide-based nanosheet is a crystalline compound having horizontal (W) and vertical (V) lengths of 500 nm or less.

6. A cathode comprising the cathode active material of claim 1.

7. An electrochemical device containing the cathode of claim 6.

8. An electrochemical device of claim 7 configured as a magnesium battery

9. A magnesium battery of claim 8 also comprising an anode; and
an electrolyte disposed to contact the cathode and the anode.

10. The magnesium battery of claim 9, wherein the anode comprises an anode active material which is subject to oxidation to produce magnesium ions.

11. The magnesium battery of claim 10, wherein the anode active material comprises at least one material selected from the group consisting of monolithic magnesium and magnesium-containing alloys.

12. The magnesium battery of claim 9, wherein the electrolyte is a non-aqueous electrolyte comprising magnesium ions.

13. The magnesium battery of claim 9 configured as a secondary battery.

14. The magnesium battery of claim 9 configured as a primary battery.
